(19) United States
(12) Patent Application Publication
(10) Pub. No.: US 2007/0202823 A1
(43) Pub. Date: Aug. 30, 2007

(54) Neural network adaptive pulsed noise blanker

(75) Inventor: Donald J. Marsh, Liberty, MO (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/363,639

(22) Filed: Feb. 28, 2006

(51) Int. Cl. H04B 1/10

(52) U.S. Cl. 455/223

(57) ABSTRACT

An apparatus for generating control signals for a noise blanker switch comprises a noise replica generator, a neural network processor coupled to the noise replica generator and a pulse function generator coupled to the neural network processor. The noise replica generator is configured to generate a pulsed noise replica from a received RF signal. The neural network processor is configured to generate a new pulsed noise model by comparing the pulsed noise replica with a current pulsed noise model. The pulse function generator is configured to generate control pulses for the noise blanker switch.

### FIELD OF THE INVENTION

The present invention generally relates to the field of radio frequency receivers and, more particularly, to a neural network adaptive pulsed noise blanker.

### BACKGROUND OF THE INVENTION

Radio frequency (RF) receivers, such as those commonly used in aircraft, are subject to pulsed electrical noise that can interfere with the received signal. The pulsed electrical noise is manifested as a series of short duration, high amplitude noise pulses, commonly referred to as pulsed noise. The pulsed noise can be produced by electrical generating systems in proximity to the RF receiver, such as ignition systems.

Pulsed noise can be very difficult to suppress once it is introduced into the narrow band receiver stages. In narrow band circuits, the pulses become longer in time and can cause severe degradation of signals, which can include the destruction of multiple digital communication signals.

Currently, in order to eliminate pulsed noise, attempts are made to prevent the reception of the RF signals at times when the pulsed noise is being received with the wanted signal. Typically, this is done by activating a noise blanker switch when the pulsed noise is received. The difficulty is determining when to turn the noise blanker on and off. Different schemes have been developed to form repetitive pulse trains having pulses of fixed pulse length that can be applied to the noise blanker to stop the reception of the RF signal when there is pulsed noise. However, current methods of determining a pulse transmission are limited and can result in a loss of signal when the RF reception is turned off in the absence of noise.

Accordingly, it is desirable to provide a neural network adaptive pulsed noise blanker. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment of the present invention a method for reducing pulsed noise in RF signals comprises a first step of receiving an RF signal that includes pulsed noise. Next, a replica of the pulsed noise is generated from the RF signal. The replica of the pulsed noise is compared to a current model of the pulsed noise at a processor to produce a new pulsed noise model. Then, a noise blanker switch is controlled based on the new pulsed noise model.

In another exemplary embodiment of the present invention, an apparatus for generating control signals for a noise blanker switch comprises a noise replica generator, a neural network processor coupled to the noise replica generator and a pulse function generator coupled to the neural network processor. The noise replica generator is configured to generate a pulsed noise replica from a received RF signal. The neural network processor is configured to generate a new pulsed noise model by comparing the pulsed noise replica with a current pulsed noise model. The pulse function generator is configured to generate control pulses for the noise blanker switch.

In yet another embodiment of the present invention, a radio with reduced pulsed noise reception comprises an antenna configured to receive a RF signal having a pulsed noise component. A noise blanker switch coupled to the antenna is configured to stop the transmission of the received RF signal in the radio when set to an on state. An adaptive pulse function generator is configured to receive a replica of the pulsed noise from the RF signal and generate a series of control pulses for controlling the noise blanker switch.

### BRIEF DESCRIPTION OF THE DRAWINGS

The present invention will hereinafter be described in conjunction with the following drawing figures, wherein like numerals denote like elements, and:

FIG. 1 illustrates an exemplary block diagram of an RF receiver with adaptive pulsed noise blanking in accordance with the teachings of the present invention; and

FIG. 2 is a flow chart illustrating a method of operating an RF receiver with adaptive pulsed noise blanking in accordance with the teachings of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

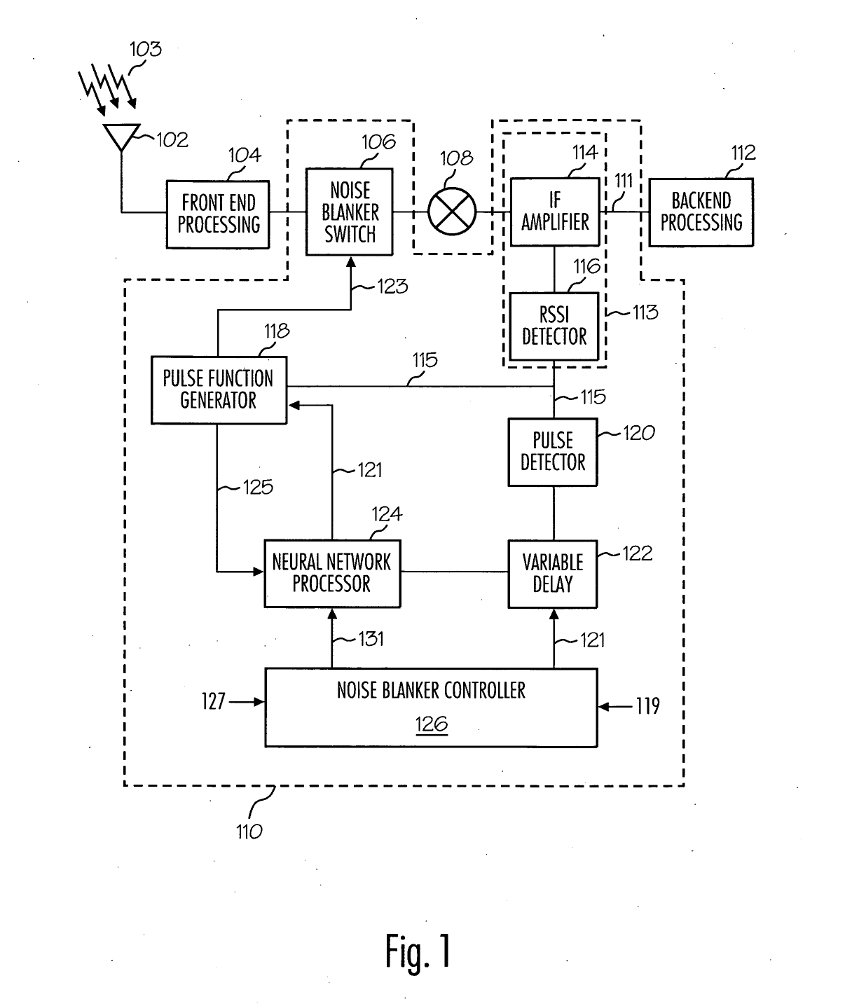

FIG. 1 illustrates an exemplary embodiment of a radio 100 with adaptive noise blanking in accordance with the teachings of the present invention. Radio 100 comprises an antenna 102 coupled to front end components 104 which are coupled to a noise blanker function 110. The noise blanker function 110 is coupled to a downconverter 108, which couples to additional back end components 112.

Antenna 102 receives RF signals 103 and is of conventional design. The front end components 104 provide any necessary filtering and amplification of the received RF signal prior to downconversion. Front end processing and the components to perform front end processing are well known in the art.

Downconverter 108 downconverts the RF signal to an intermediate frequency (IF) signal for processing. Downconverting is commonly done in RF signal processing, and any components and techniques commonly typically used to downconvert a RF signal to an IF signal can be used in the present invention.

Noise blanker function 110 generates one or more control pulses to be used to control a noise blanker switch 106 at the correct time to reduce or eliminate pulsed noise. In one exemplary embodiment of the present invention, noise blanker function 110 comprises a noise blanker switch 106 coupled to a noise replica generator 113, which in one exemplary embodiment, comprises an intermediate frequency amplifier 114 and a retrieved signal strength indication (RSSI) detector 116. The output of the RSSI detector 116 is coupled to a pulse function generator 118 and a pulse detector 120. Pulse detector 120 is coupled to a variable delay circuit 122 which couples to a neural network processor 124. Neural network processor 124 receives an input from and provides an output to the pulse function generator 118. A noise blanker controller 126 is coupled to the neural network processor 124.

Noise blanker switch 106, when triggered, prevents the further transmission of the RF signal in the radio 100, essentially turning off the radio momentarily. In order to prevent the processing of pulsed noise, the noise blanker switch 106 can be switched on when pulsed noise is present in the RF signal, which stops the transmission of the RF signal and the associated pulsed noise in the radio 100. Of course, turning on the noise blanker switch 106 at the proper time can be difficult. In the present invention, the noise blanker switch 106 is controlled by the noise blanker function 110 which provides control signals for turning on and off the noise blanker switch 106 at the proper time to substantially reduce or eliminate pulsed noise.

Noise replica generator 113 produces a pulsed noise replica 115 that comprises a replica of the pulsed noise extracted from the received RF signal 103. In one exemplary embodiment, the IF amplifier 114 amplifies the output of the downconverter 108. The RSSI detector 116 produces a pulsed noise replica 115 having a large dynamic range. The IF amplifier 114 also produces an amplified IF signal 111 for back end components 112, which can include signal processing components.

The pulsed noise replica 115 is provided to the pulse detector 120. Pulse detector 120 determines the location of the noise pulses in the pulsed noise replica 115 using standard threshold detection techniques that detect pulses exceeding a certain magnitude. The output of the pulse detector 120 is received by variable delay circuit 122 which corrects time delays in the pulses detected by the pulse detector 120. Time delays may be caused by the downconversion of the RF signal 103 to form a corrected pulsed noise replica 117.

Neural network processor 124 receives the corrected pulsed noise replica 117 from the variable delay circuit 122 and pulse parameters 125 from a current model of the pulsed noise from the pulse function generator 118, as discussed in further below, to determine a new pulsed noise model 121. Neural network processor 124 can comprise a number of individual interconnected processor units that respond in parallel to a given input. The interconnected processors can be weighted and the neural network processor 124 may include activation rules, which act on the set of inputs to generate output signals and learning rules that specify how to adjust weighting of the processors. In one exemplary embodiment, a least square fit estimate of a match between the corrected pulsed noise replica 117 and the current pulsed noise model is used to generate the new pulsed noise model that can be used to generate control pulses. While a neural network processor represents a preferred embodiment, any processor or similar device that can compute pulsed noise models from a comparison of the received pulsed noise and a pulsed noise model can be used.

Pulse function generator 118 generates control pulses 123 to control noise blanker switch 106. The control pulses 123 are generated using the new pulsed noise model 121 received from the neural network processor 124. The pulse function generator 118 also outputs pulse parameters 125, which can be used by the neural network processor 124 as the current pulsed noise model. When the pulse function generator 118 receives the new pulsed noise model 121, the new pulsed noise model 121 becomes the current pulsed noise model, which is output to the neural network processor as the pulse parameters 125. The generation of new pulsed noise models using current pulsed noise models that are updated with the new pulsed noise model helps to make more exact and adaptive control pulses 123.

The control pulses 123 generated by the pulse function generator 118 are outputted to the noise blanker switch 106. Each pulse in the control pulses 123 controls the noise blanker switch 106 to prevent transmission of the received RF signal 103. When a control pulse 123 ends, the noise blanker switch 106 is set to allow transmission of the RF signal 103 to continue. Since the control pulses 123 are matched to the received pulsed noise, the noise blanker switch 106 will reduce or eliminate the received pulsed noise.

Noise blanker controller 126 provides command signals 131 for the operation of neural network processor 124. In one exemplary embodiment, noise blanker controller 126 receives a signal strength measurement 127 indicative of the signal strength of the received RF signal 103. If the received RF signal 103 strength is below a certain threshold, then the amount of noise in the received RF signal 103 is large and the noise blanker switch 106 is needed to reduce pulsed noise. In one exemplary embodiment, the noise blanker controller can send the correct command signal 131 to initiate the operation of the neural network processor 124. The RF signal 103 strength can be determined, in one exemplary embodiment, by the back end components 112. Command signals 131 can comprise additional commands and information needed by the neural network processor 124.

Noise blanker controller 126 can also receive an error measure 119 indicative of an error margin to be used in the calculations within neural network processor 124. The error measure 119 can be sent to the neural network processor 124 via command signal 131 and can be used in the least the square fit estimate to determine when to stop calculations.

Noise blanker controller 126 can also produce delay control signals 129 for the variable delay circuit 122. The delay control signals 129 are signals used by the variable delay circuit 122 to determine the correct delay for pulsed noise replica 115.

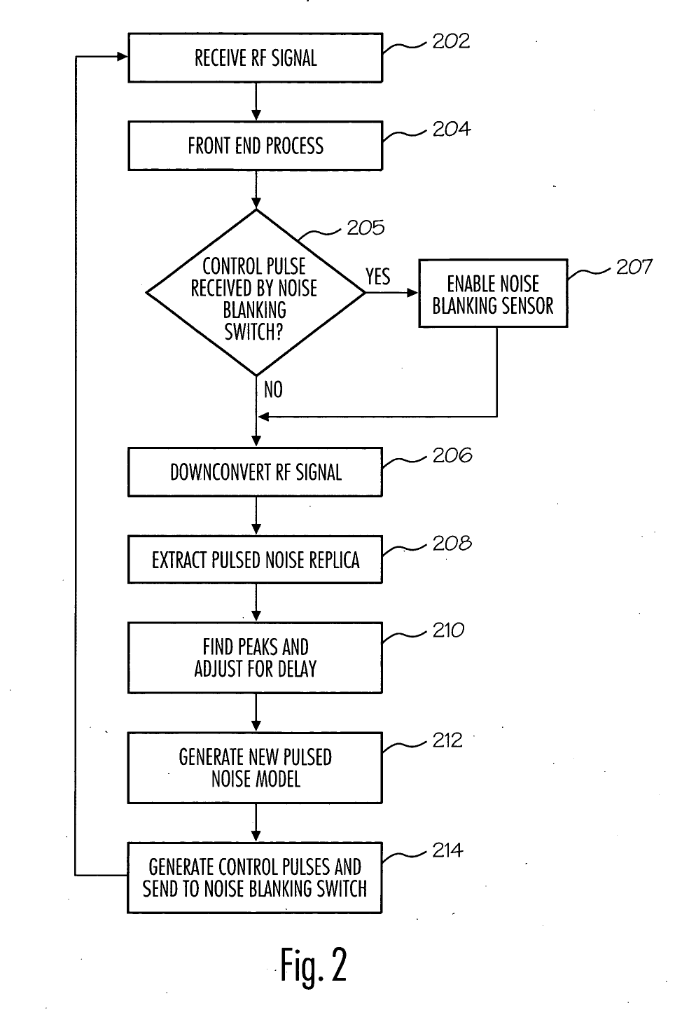

FIG. 2 is a flowchart illustrating an exemplary method for operating a noise blanker switch, such as the above described noise blanker switch 106 in accordance with the teachings of the present invention. In a first step, step 202, a RF signal 103 with pulsed noise is received at the antenna 102. Next, in step 204, all necessary front end processing is accomplished at front end components 104.

In step 205, it is determined if the noise blanker switch 106 has received a control pulse. If the noise blanker switch 106 has received a control pulse, then, in step 207, the noise blanker switch 106 is switched to prevent transmission of the RF signal 103.

In step 206, the RF signal 103 is downconverted at the downconverter 108. As discussed previously, any method of downconversion can be used.

In step 208, the pulsed noise replica 115 is extracted from the received RF signal 103 at the noise replica generator 113. The pulses in the pulsed noise replica 115 are detected at the pulse detector 120 and the pulsed noise replica 115 is adjusted for time delays caused by the signal processing through the radio 100 at the variable delay circuit 122 in step 210.

In step 212, the pulsed noise replica 115 is compared to a current pulsed noise model at the neural network processor 124. The pulse parameters 125 can be supplied by the pulse function generator 118 for use as the current pulsed noise model. In one embodiment, the neural network processor 124 utilizes a least square estimate to compare the pulsed noise replica 115 to the current pulsed noise model to develop a new pulsed noise model. The new pulsed noise model can then be used as the current pulsed noise model in the next comparison with the pulsed noise replica 115.

In step 214, the new pulsed noise model is received by the pulse function generator 118 to generate control pulses 123 to send to the noise blanker switch 106 to control the operation of the noise blanker switch 106. The control pulses 123 generated by the pulse function generator 118 will cause the noise blanker switch 106 to stop the received RF signal 103 from propagating in the radio 100 when the pulsed noise in the RF signal 103 is present, thus reducing or eliminating the received pulsed noise.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for reducing pulsed noise in RF signals comprising:
receiving the RF signal containing pulsed noise;
generating a replica of the pulsed noise from the RF signal;
comparing the replica of the pulsed noise to a current pulsed noise model to produce a new pulsed noise model; and
controlling a noise blanker switch based on the new pulsed noise model.

2. The method of claim 1 wherein the step of controlling a noise blanker switch further comprises generating control pulses at a pulse generator using the new pulsed noise model.

3. The method of claim 1 further comprising, before the step of comparing the replica of the pulsed noise, the steps of:
receiving a signal strength measurement at a noise blanker controller; and
executing the step of receiving the RF signal if the signal strength measurement is above a threshold.

4. The method of claim 1 wherein the step of generating a replica of the pulsed noise comprises extracting the replica of a pulsed noise signal from the RF signal at a noise replica generator.

5. The method of claim 1 further comprising detecting noise pulses in the replica of the pulsed noise at a pulse detector and correcting for time delay of the replica of the pulsed noise before the step of comparing the replica of the pulsed noise.

6. The method of claim 1 wherein the step of comparing the replica of the pulsed noise further comprises using a least square estimate to compare the replica of the pulsed noise with the current pulsed noise model.

7. The method of claim 6 wherein the step of comparing the replica of the pulsed noise further comprises comparing the replica of the pulsed noise to the current pulsed noise model at a neural network processor.

8. The method of claim 1 further comprising replacing the current pulsed noise model with the new pulsed noise model for use in a future comparison at a neural network processor.

9. An apparatus for generating control signals for a noise blanker switch comprising:
a noise replica generator configured to generate a pulsed noise replica;
a neural network processor coupled to the noise replica generator, the neural network processor configured to generate a new pulsed noise model by comparing the pulsed noise replica with a current pulsed noise model; and
a pulse function generator coupled to the neural network processor and configured to generate control pulses for the noise blanker switch using the new pulsed noise model.

10. The apparatus of claim 9 wherein the pulsed noise replica is formed from an RF signal having a pulsed noise component.

11. The apparatus of claim 10 wherein the pulsed noise replica is produced by a noise replica generator comprising an IF amplifier and a received signal strength indicator detector.

12. The apparatus of claim 9 further comprising a noise blanker controller configured to activate the neural network processor if a measure of the received signal strength is less than a predetermined threshold.

13. The apparatus of claim 9 wherein the apparatus further comprises a pulse detector configured to detect noise pulses in the pulsed noise replica.

14. The apparatus of claim 9 wherein the neural network processor utilizes a least square fit calculation to compare the pulsed noise replica and the current pulsed noise model.

15. The apparatus of claim 9 further comprising a delay circuit for adjusting a time delay of the pulsed noise replica.

16. A radio with reduced pulsed noise reception comprising:
an antenna configured to receive a RF signal having a pulsed noise component; and
a noise blanker function coupled to the antenna and configured to stop the transmission of the received RF signal based on a pulsed noise model generated by a replica of the pulsed noise received in the RF signal.

17. The radio of claim 16 wherein the noise blanker function comprises:
a noise blanker switch coupled to the antenna and configured to stop the transmission of RF signals upon receiving control signals;
a noise replica generator coupled to the noise blanker switch and configured to generate the replica of the pulsed noise;
a neural network processor coupled to the noise replica generator, the neural network processor configured to generate a new pulsed noise model by comparing the pulsed noise replica with a current pulsed noise model; and
a pulse function generator coupled to the neural network processor and configured to generate control signals for the noise blanker switch using the new pulsed noise model.

18. The radio of claim 17 wherein the noise replica generator comprises an IF amplifier coupled to a received signal strength detector.

19. The radio of claim 17 wherein the noise blanker function further comprises a pulse detector configured to detect noise pulses in the pulsed noise replica.

20. The radio of claim 17 wherein the neural network processor utilizes a least square fit estimation to compare the pulsed noise replica and the current pulsed noise model.
